(19) United States
(12) Patent Application Publication
(10) Pub. No.: US 2009/0144100 A1
(43) Pub. Date: Jun. 4, 2009

(54) METHOD AND SYSTEM FOR DEVIATION ANALYSIS

(76) Inventors: Eduard Korat, Campbell, CA (US); Torsten Heise, Wiesloch (DE)

Correspondence Address: SAP AG, 3410 HILLVIEW AVENUE, PALO ALTO, CA, 94304, US

(21) Appl. No.: 11/947,806

(22) Filed: Nov. 30, 2007

(51) Int. Cl. G06F 17/30

(52) U.S. Cl. 705/7

(57) ABSTRACT

Disclosed is a method and system for generating a deviation result for a work order. The generation of the deviation analysis results involves initiating a deviation analysis for a work order, determining a comparison group for deviation analysis based on an available data and a planned data, generating a deviation analysis result for the comparison group and updating a status of the work order with the deviation analysis result.

### FIELD OF THE INVENTION

The invention generally relates to the field of a supply chain management and more specifically relates to the field of a deviation analysis result for a work order.

### BACKGROUND OF THE INVENTION

In a supply chain management, orders given by a customer to a supplier have to be processed typically within a specified period of time. A customer order for a finished product drives the supply chain management. Each customer order has a request date by which the customer would like to receive the complete order. Receiving the completed order depends on a supplier manufacturing process. To efficiently track the order the customer will need consolidated information of the order including time taken to manufacture a product, initial start date of the manufacture process, probable end date of the manufacture process. Typically tracking the order involves determining a deviation result for the order at a final delivery stage. The existing methods and systems typically do not meet the need of tracking the order determining the deviation result for the order using a time tolerance and a quantity tolerance.

### SUMMARY OF THE INVENTION

Disclosed is a method and system for generating a deviation result for a work order. The generation of the deviation analysis results involves initiating a deviation analysis for a work order, determining a comparison group for the deviation analysis based on an available data and a planned data, generating a deviation analysis result for the comparison group and updating a status of the work order with the deviation analysis result.

### BRIEF DESCRIPTION OF THE DRAWINGS

A better understanding of embodiments of the invention are illustrated by examples and not by way of limitation, the embodiments can be obtained from the following detailed description in conjunction with the following drawings, in which:

FIG. 1 is flow diagram for generating a deviation analysis result for a work order according to an embodiment of the invention.

FIG. 2 is a flow diagram for determining a comparison group for the deviation analysis for the work order according to an embodiment of the invention.

FIG. 3 is an exemplary block diagram for determining a comparison group within time tolerance according to an embodiment of the invention.

FIG. 4 is an exemplary block diagram for determining a comparison group not in time tolerance according to an embodiment of the invention.

FIG. 5 is a block diagram for generating a deviation analysis result for a work order according to an embodiment of the invention.

### DETAILED DESCRIPTION

Disclosed is a method and system for generating a deviation result for a work order. The generation of the deviation analysis results involves initiating a deviation analysis for a work order, determining a comparison group based on an available data and a planned data, generating a deviation analysis result for the comparison group and updating a status of the work order with the deviation analysis result.

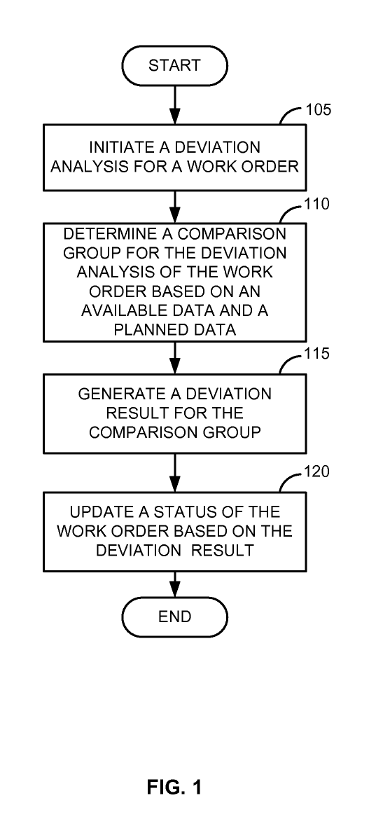

FIG. 1 is flow diagram for generating a deviation analysis result for a work order according to an embodiment of the invention. At process block 105, a deviation analysis is initiated for a work order. The work order includes customer-provided request information, a supplier-provided confirmation and an actual information, and system-generated projected information. In an embodiment, the deviation analysis is initiated by a customer evaluating a supplier work order confirmation. In another embodiment the deviation analysis is initiated by a system event triggering a work order progress check. At process block 110, a comparison group for the deviation analysis for the work order is determined based on an available data and a planned data. A deviation result for the comparison group is generated at process block 115. The deviation result for the comparison group further includes generating a quantity tolerance result and time tolerance result for the comparison group. A status for the work order is updated based on the deviation result at process block 120. In an embodiment, updating a status of the work order includes the system accepting the status which is within a quantity tolerance value and a time tolerance value on behalf of a user. In another embodiment, the system sets toleration violation status. The tolerance violation status also generates a task and an alert for an administrator to address a problem.

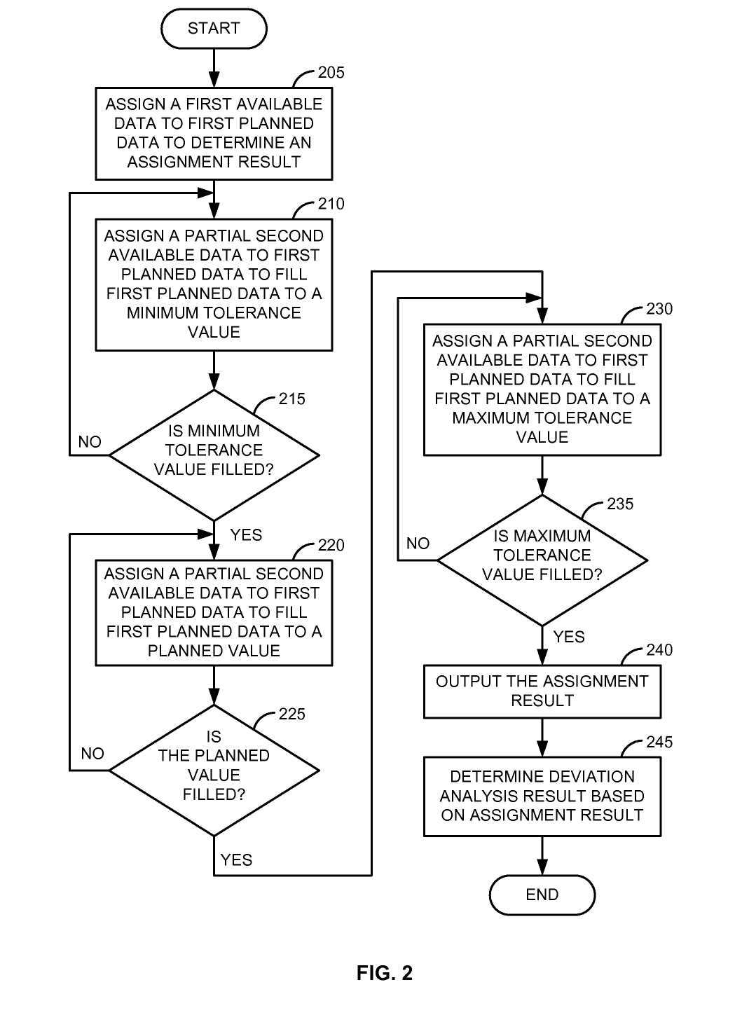

FIG. 2 is a flow diagram for determining a comparison group for the deviation analysis for the work order. The determination of the comparison group involves determining an assignment result and a deviation result. The determination of the comparison group is based on an available data and a planned data. A first available data is assigned to a first planned data to determine the assignment result at process block 205. The assignment result is determined by assigning the available data to the planned data to fill a minimum tolerance value, a planned value and a maximum tolerance value. A partial second available data is assigned to the first planned data to fill the first planned data to a minimum tolerance value at process block 210. At decision point 215, if the minimum tolerance value of the first planned data is filled by the second available data the process proceeds to process block 220. At decision point 215, if the minimum tolerance value of the first planned data is not filled the second available data the process proceeds to process block 210. A plurality of planned data is filled to the minimum tolerance value by a plurality of available data as defined in a work order. The partial second available data is assigned to the first planned data to fill the first planned data to a planned value at process block 220. At decision point 225, if the planned value of the planned data is filled by the available data, the process proceeds to process block 230. At decision point 225, if the planned value of the planned data is not filled by the second partial available data the process proceeds to process block 220. The partial second available data is assigned to the first planned data to fill the first planned data to a maximum tolerance value at process block 230. At decision point 235, if the maximum tolerance value of the first planned data is filled by the available data the process proceeds to process block 240. At decision point 235, if the planned value of planned data is not filled by the partial second available data the process proceeds to process block 230. The assignment result is output at process block 240. A deviation result is determined based on the assignment result at process block 245.

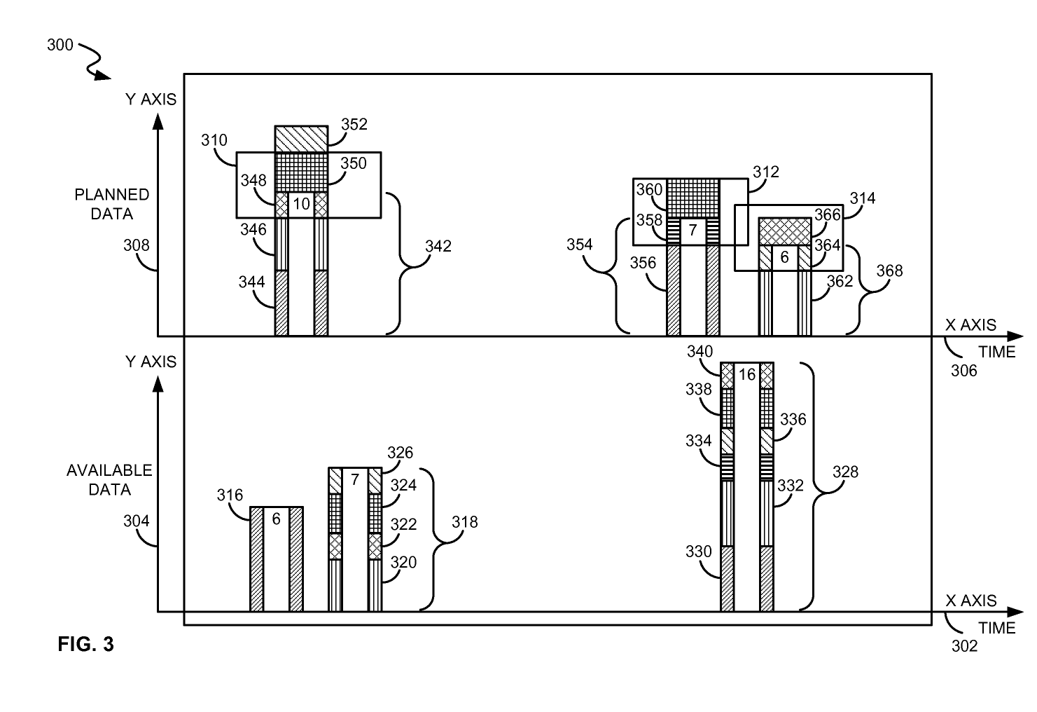

FIG. 3 is an exemplary block diagram for determining a comparison group within time tolerance according to an embodiment of the invention. The determination of the comparison group involves determining an assignment result and a deviation result. Consider a first X-Y axis a business scenario 300, where X axis 302 defines time instance and Y axis 304 defines an available data. The available data includes a quantity of a product. A second X-Y axis where X axis 306 defines time instance and Y axis 308 defines a planned data. The planned data has a quantity of a product at a time instance. In an embodiment, the planned data is a customer requested data and the available data is a supplier confirmation data.

In business scenario 300, there are three available data, namely a first available data 316, a second available data 318 and a third available data 328 mathematically denoted as Dₐ¹, Dₐ², Dₐ³ respectively. The business scenario 300 has three planned data namely a first planned data 342, a second planned data 354, a third planned data 368 denoted as Dₚ¹, Dₚ², Dₚ³ respectively. In business scenario 300, the planned data is in format Dₚ=[Tₚ, Qₚ; Tₚ^{min}, Tₚ^{max}, Qₚ^{min}, Qₚ^{max}], where Dₚ=planned data, Tₚ=planned time, Qₚ=planned value, Tₚ^{min}=minimum tolerance time value, Tₚ^{max}=maximum tolerance time value, Qₚ^{min}=minimum tolerance quantity value, Qₚ^{max}=maximum tolerance quantity value. The available data is in format Dₐ=[Tₐ, Qₐ], where Tₐ=available time, Qₐ=available quantity.

In business scenario 300, a first planned data 344 is Dₚ¹=[T₁, 10, T₁−2 days, T₁+1 day, 9, 12] where planned time is at time instance T₁, planned value is 10, minimum time tolerance value is T₁−2 days means 2 days lesser than the planned time, maximum time tolerance value is T₁+1 day means 1 day more than the planned time, minimum quantity tolerance value is 9, maximum quantity tolerance value is 12. A second planned data 356 is Dₚ²=[T₂, 7, T₂−2 days, T₂+1 days, 6, 9] where planned time is instance T₂, planned value is 7, minimum time tolerance value is T₂−2 days means 2 days lesser than the planned time, maximum time tolerance value is T₂+1 day means 1 day more than the planned time, minimum quantity tolerance value is 6, maximum quantity tolerance value is 9. A third planned data 362 is Dₚ³=[T₂+2 days, 6, T₂, T₂+3 days, 5, 8] where planned time is time instance T₂+2 d means 2 days more than the planned time, planned value is 6, minimum time tolerance value is T₂, maximum time tolerance value is T₂+3 days, minimum quantity tolerance value is 5, maximum tolerance value is 8. In business scenario 300, first available data is Dₐ¹=[T₁−2 days, 6], where available time is time instance T₁−2 days means 2 days lesser than the planned time, available quantity is 6, second available data is Dₐ²=[T₁+1 day, 7] where available time is time instance T₁+1 day means 1 day more than the planned time, available quantity is 7. A third available data is Dₐ³=[T₂, 16] where available time is time instance T₂ and available quantity is 16. The available data and the planned data can be visualized in a table format for better understanding.

Planned data is as given below:

| Dₚ | Tₚ | Qₚ | Tₚ^{min} | Tₚ^{max} | Qₚ^{min} | Qₚ^{max} |
|---|---|---|---|---|---|---|
| Dₚ¹ | T₁ | 10 | T₁ − 2 days | T₁ + 1 day | 9 | 12 |
| Dₚ² | T₂ | 7 | T₂ − 2 days | T₂ + 1 day | 6 | 9 |
| Dₚ³ | T₂ + 2 days | 6 | T₂ | T₂ + 3 days | 5 | 8 |

Available data is as given below:

| Dₐ | Tₐ | Qₐ |
|---|---|---|
| Dₐ¹ | T₁ − 2 days | 6 |
| Dₐ² | T₁ + 1 day | 7 |
| Dₐ³ | T₂ | 16 |

In business scenario 300, there are three available data namely the first available data 316, the second available data 318 and the third available data 328 mathematically denoted as Dₐ¹, Dₐ², Dₐ³ respectively. The business scenario 300 has three planned data namely a first planned data 342, a second planned data 354, a third planned data 368 denoted as Dₚ¹, Dₚ², Dₚ³ respectively. A first available data 316 with available quantity 6, a second planned data 318 with planned value 7 lie within the time tolerance of a tolerance box 310 of the first planned data 342 with planned value 10. The third available data 328 with available quantity 16 lies within the time tolerance of a tolerance box 312 of the second planned data 354 with planned value 7 and the third planned data 368 with planned value 6.

Determining a comparison group includes determining an assignment result and a deviation result. The determination of the assignment result includes filling the planned data to a minimum tolerance value, a planned value and a maximum tolerance value.

In tolerance box 310 for the first planned data 342 a minimum quantity tolerance value is 9, a maximum quantity tolerance value is 12 and a planned value is 10. In tolerance box 310 for the first planned data 342 a minimum time tolerance value is T₁−2 days and a maximum time tolerance value is T₁+2 days. In tolerance box 312 for the second planned data 354 a minimum quantity tolerance value is 6, a maximum quantity tolerance value is 9 and a planned value is 7. In tolerance box 312 for the second planned data 354 a minimum time tolerance value is T₂−2 days and a maximum time tolerance value is T₂+2 days. In tolerance box 314 for the third planned data 368 a minimum quantity tolerance value is 5, a maximum quantity tolerance value is 8 and a planned value is 6. In tolerance box 314 for the third planned data 368 a minimum time tolerance value is T₂ and a maximum time tolerance value is T₂+3 days.

The determination of the assignment further includes assigning the first available data 316 with available quantity 6 and second available data 318 with available quantity 7 to the first planned data 342 as the first available data 316 and the second available data 318 lie in a time tolerance of the tolerance box 310. Assign the third available data 328 with available quantity 16 to the second planned data 354 with planned value 7 and third planned data 368 with planned value 6 as the third available data 328 lies within time tolerance of tolerance box 312 and tolerance box 314. In mathematical notation: Dₐ¹→Dₚ¹, Dₐ²→Dₚ¹, Dₐ³→Dₚ², Dₚ³. Consider filling the first planned data 342, the second planned data 354 and the third planned data 368 to a minimum tolerance value. Assign full planned quantity 6 of the first available data 316 to the first planned data 342. The assigned first available data 316 fills the planned data 342 as first partial planned data 344. In mathematical notation: Dₐ¹[6]+Dₚ¹. In the next step assign a second partial available data 320 with quantity 3 of second available data 318 to the first planned data 342 to fill planned data 342 to its minimum tolerance value with quantity 9. The assigned second partial available data 320 fills the first planned data 342 as a second partial planned data 346. In mathematical notation: Dₐ¹[6]+Dₐ²[3]→Dₚ¹. Filling the minimum tolerance value 9 of the first planned data is achieved by summing up the first partial planned data 344 and the second partial planned data 346. Assign a first available partial data 330 with quantity 6 of the third available data 328 to the second planned data 354 to fill the minimum tolerance value 6 of second planned data 354. The assigned first available partial data 330 fills the second planned data 342 as first partial planned data 354. In mathematical notation: Dₐ³[6]→Dₚ². Assign second partial data 332 with quantity 3 of the third available data 328 to third planned data 368 to fill minimum tolerance value 5 of the third planned data 368. The assigned second partial available data 332 of the third available data 328 fills the third planned data 368 as the first planned partial data 362. In mathematical notation: Dₐ³[5]→Dₚ³. The minimum tolerance value for the first planned data 342, the second planned data 354 and the third planned data 368 is filled by the first available data 316, the second available data 318 and the third available data 328 based on a scenario defined by the work order.

Consider filling the first planned data 342, the second planned data 354 and the third planned data 368 to a planned value. The planned value of the first planned data 342 is 10, the second planned data 354 is 7 and the third planned data 368 is 5. Assign full quantity 6 of the first available data 316 to first planned data 342. The assigned first available data 316 fills the first planned data 342 as the first planned partial data 344. In mathematical notation: Dₐ¹[6]→Dₚ¹. Assign second available partial data 322 with quantity 4 of the second available data 318 to the first planned data 342 to fill planned value. The assigned second available partial data 322 fills the first planned data 342 as a third planned partial data 348. In mathematical notation: Dₐ¹[4]→Dₚ¹. Filling the planned value is achieved by summing first available data 316 and the third planned partial data 348. In mathematical notation: Dₐ¹[6]+Dₐ¹[4]→Dₚ¹. Assign third partial available data 334 with quantity 7 of the third available data 328 to the second planned data 354 to fill planned value. The assigned third partial available data 334 fills the planned data 354 as a second partial planned data 358. In mathematical notation: Dₐ³[7]→Dₚ². Assign a fourth available partial data 336 with quantity 6 of third available data 328 to third planned data 368 to fill planned value. The assigned fourth available partial data 336 fills the third planned data 368 as a second planned partial data 364. In mathematical notation: Dₐ³[6]→Dₛ³. The planned value for the first planned data 342, the second planned data 354 and the third planned data 368 is filled by the first available data 316, the second available data 318 and the third available data 328 based on a scenario defined by the work order.

Consider filling the first planned data 342, the second planned data 354 and the third planned data 368 to a maximum tolerance value. The maximum tolerance value of the planned data is filled by the quantity available data based on the scenario defined by the work order. The maximum tolerance value of the first planned data 342 is 12, the second planned data 354 is 9 and the third planned data 368 is 8. Assign quantity 6 of first available data 316 to the second planned data 342. In mathematical notation: Dₐ¹[6]→Dₚ¹. Assign a fourth available partial data 326 with quantity 6 of the second available data 318 to the first planned data 342 to fill the first planned data 342 to maximum tolerance value 12. The assigned fourth available partial data 326 of the second available data 318 fills the first planned data 342 as a fourth planned partial data 350. Filling the maximum tolerance value of the first planned data 342 is achieved by summing first available data 316 and the third partial available data 324. In mathematical notation: Dₐ¹[6]+Dₐ²[6]→Dₚ¹. Assign a fifth available partial data 338 with quantity 9 of the third available data 328 the second planned 354 data to fill maximum tolerance value 9. The fifth available partial data 338 of the third available data 328 fills the second planned data 354 as a third partial planned data 360. In mathematical notation: Dₐ³[9]→Dₚ². Assign sixth available partial data 340 with quantity 7 of the third planned data 328 to third planned quantity 368 to fill maximum tolerance value 8. The sixth available partial data 340 fills the third planned data 368 as third partial planned data 366. In mathematical notation: Dₐ³[7]→Dₚ³, resulting in having assigned the full quantity of 16 of Dₐ³ filling almost the maximum tolerance value 8 of Dₐ³. Assign the partial quantity of the second available data 318 to the first planned data 342 exceeding its tolerable maximum value. So now we have Dₐ¹[6]+Dₐ²[7]→Dₚ¹, thus assigning a total of 13 and thereby exceeding the maximum tolerance value 12 of first planned data 342 by quantity 1 shown as fifth planned partial data 352 in the first planned data 342. The assignment result for business scenario 300 in mathematical notation is, first assignment result is Dₐ¹[T₁−2 days, 6]+Dₐ²[T₁+1 day, 7]→Dₚ¹[T₁, 10, T₁−2 days, T₁+1 day, 9, 12], second assignment result is Dₐ³[T₂, 9]→Dₚ²[T₂, 7, T₂−2 days, T₂+1 day, 6, 9] and third assignment result is Dₐ³[T₂, 7]→Dₚ³[T₂+2 days, 6, T₂, T₂+3 days, 5, 8]

A deviation result is generated based on the assignment result. For every planned data event of work order there is the deviation analysis result. The deviation result includes of a quantity tolerance result and a time tolerance result. The quantity tolerance result may include low quantity, quantity within tolerance, high quantity. For each planned data the quantity result is determined by a total quantity which was assigned to it from the available data. If the total assigned quantity lies below the minimum tolerance value the result is low quantity. If the total assigned quantity lies between the minimum tolerance value and the maximum tolerance value, the result is quantity within tolerance. If the total assigned quantity lies above the maximum tolerance value the result is high quantity.

The time tolerance result may include early completion, completion time within tolerance and late completion. If the earliest assigned available data is earlier than the minimum time tolerance value and no assigned data is later than the maximum time tolerance value, the result is early completion. If all assigned available data lie within the minimum time tolerance value and the maximum time tolerance value, the result is completion within tolerance. If there is one assigned available data which lies above the upper time limit the result is late completion.

In business scenario 300, the time instance of the available data in the first assignment result lie within the tolerance of the planned data. In mathematical notation: T₁−2 days, T₁+1 dayε[T₁−2, T₁+1 day]. The total quantity 6+7=13 of the assigned available data lies above the maximum quantity tolerance value [9, 12] of the planned data. The deviation result for the first planned data 342 is high quantity, completion time within tolerance value.

The time instance of the available data in the second assignment lies within the tolerance of the planned data. In mathematical notation: T₂ε[T₂−2, T₂+1 day]. The quantity 9 of the available data is equal to the maximum quantity tolerance value of the planned data [6, 9]. The deviation result for the second planned data 354 is quantity within tolerance value, completion time within tolerance.

The time instance of the available data in the third assignment lies within the tolerance of the planned data. In mathematical notation T₂ε[T₂, T₂+3 days]. The quantity 7 of the available data lies within the maximum quantity tolerance value of the planned data [5, 8]. The deviation result for the third planned data 368 is quantity within tolerance value, completion time within tolerance.

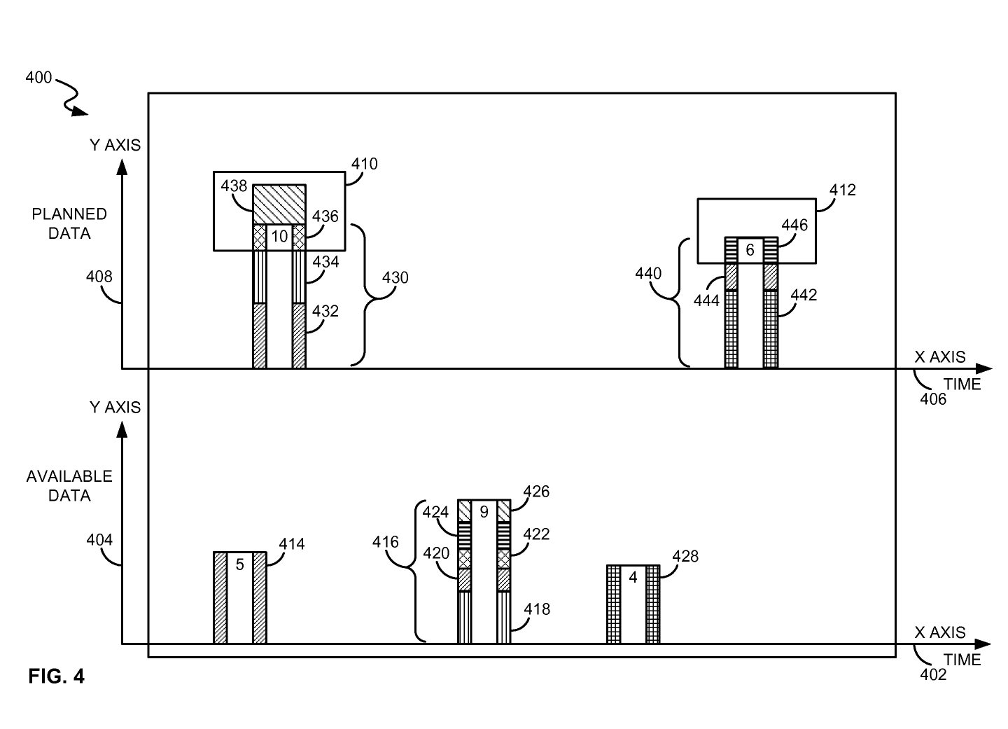

FIG. 4 is an exemplary block diagram for determining a comparison group not in time tolerance according to an embodiment of the invention. Consider a first X-Y axis in business scenario 400 where X axis 402 defines time instance and first Y axis 404 defines available data. The available data includes a product and a quantity. A second X Y axis where X axis 406 defines time and Y axis 408 defines planned data. The planned data has a quantity at a time instance. In an embodiment the planned data is a customer requested data and the available data is a supplier confirmation data.

Consider business scenario 400, where planned data is in format Dₚ=[Tₚ, Qₚ, Tₚ^{min}, Tₚ^{max}, Qₚ^{min}, Qₚ^{max}], where Dₚ=planned data, Tₚ=planned time, Qₚ=planned value, Tₚ^{min}=minimum tolerance time, Tₚ^{max}=maximum tolerance time, Qₚ^{max}=minimum tolerance quantity, Qₚ^{max}=maximum tolerance quantity. Available data is in format Dₐ=[Tₐ, Qₐ], where Tₐ=available time, Qₐ=available quantity.

In business scenario 400, a first planned data is Dₚ¹=[T₁, 10, T₁−2 days, T₁+1 day, 9, 12] where planned time is at time instance T₁, planned value is 10; minimum time tolerance value is T₁−2 days means 2 days lesser than the planned time, maximum time tolerance value is T₁+1 day means 1 day more than the planned time, minimum quantity tolerance value is 9, maximum quantity tolerance value is 12. A second planned data is Dₚ²=[T₁+15, 6, T₁+13 days, T₁+16 days, 5, 8] where planned time instance is T₁+15 days, planned value is 6, minimum time tolerance value is T₁+13 days means 12 days more than the planned time, maximum time tolerance value is T₂+16 days means 16 days more than the planned time, minimum quantity tolerance value is 5, maximum quantity tolerance value is 8. In business scenario 400, first available data is Dₐ¹=[T₁−2 days, 5], where available time is T₁−2 days means 2 days lesser than the planned time, available quantity is 5, second available data is Dₐ²=[T₁+5 day, 9] where available time is time instance T₁+5 day means 5 days more than the planned time, available quantity is 9. A third available data is Dₐ³=[T₁+11 days, 3] where available time is T₁+11 days and available quantity is 3.

The available data and the planned data can be visualized in a table format for better understanding

Planned data is as given below:

| Dₚ | Tₚ | Qₚ | Tₚ^{min} | Tₚ^{max} | Qₚ^{min} | Qₚ^{max} |
|---|---|---|---|---|---|---|
| Dₚ¹ | T₁ | 10 | T₁ − 2 days | T₁ + 1 day | 9 | 12 |
| Dₚ² | T₁ + 15 | 6 | T₁ + 13 days | T₁ + 16 days | 5 | 8 |

Available data is as given below:

| Dₐ | Tₐ | Qₐ |
|---|---|---|
| Dₐ¹ | T₁ − 2 days | 5 |
| Dₐ² | T₁ + 5 days | 9 |
| Dₐ³ | T₁ + 11 days | 3 |

In business scenario 400, there are three available data namely first available data 414, second available data 416 and third available data 428 mathematically denoted as Dₐ¹, Dₐ², Dₐ³ respectively. Business scenario 400 has two planned data namely first planned data 430 and second planned data 440 mathematically denoted as Dₚ¹ and Dₚ² respectively. A first available data 414 with quantity 5 lies within the time tolerance box 410 of the first planned data 430 with quantity 10. A second available data 416 with quantity 9 and a third available data 428 with quantity 4 do not lie within the tolerance box 410 of the first planned data 430 and the tolerance box 412 of the second planned data 440.

Determining a comparison group includes determining an assignment result and a deviation result. The determination of the assignment result includes filling the planned data to a minimum tolerance value, planned value and a maximum tolerance value.

In tolerance box 410 for the first planned data 430 a minimum quantity tolerance value is 9, a maximum quantity tolerance value is 12 and a planned value is 10. In tolerance box 410 for the first planned data 430 a minimum time tolerance value is T₁−2 days and a maximum time tolerance value is T₁+2 days. In tolerance box 412 for the second planned data 440 a minimum quantity tolerance value is 5, a maximum quantity tolerance value is 8 and a planned value is 6. In tolerance box 412 for the second planned data 440 a minimum time tolerance value is T₁+13 days and a maximum time tolerance value is T₁+16 days.

The determination of the assignment further includes assigning the first available data 414 to the first planned data 430. In mathematical notation: Dₐ¹→Dₚ¹. Assign the first available data 414 with quantity 5 to the first planned data 430. The first available data 414 fills the first planned data as a first partial planned data 432. In mathematical notation: Dₐ¹[5]→Dₚ¹. Since the second available quantity 416 and the third available quantity 428 do not lie within the time tolerance box 412 they are not assigned to the second planned data 440. Considering the time instances of the second available data 416 and the third available data 428, they are assigned to the first planned data 430 and the second planned data 440 based on the time instances. In the next step assign third available data 428 with quantity 4 to the second planned data 440. The third available data 428 fills the second planned data 440 as a first partial planned data 442. In mathematical notation Dₐ³[3]→Dₚ².

Consider filling the first planned data 430 and the second planned data 440 to its minimum tolerance value. The third available data 428 is closer in time to the second planned data 440 than the first planned data 430. Assign first available partial data 418 with quantity 4 of the second available data 416 to the first planned data 430 to fill the first planned data 430 to its minimum tolerance value 9. The second available data 416 fills the first planned data 430 as a second partial planned data 434. Filling the minimum tolerance value of the first planned data 430 is achieved by summing first available data 414 and the first partial available data 418. In mathematical notation Dₐ¹[5]+Dₐ²[4]→Dₛ¹. Assign second partial available data 420 with quantity 2 to the second planned data 440 to fill the second planned data 440 to its minimum tolerance value 5. The second partial available data 420 fills the second planned data 440 as a second partial planned data 444. In mathematical notation: Dₐ²[2]+Dₐ³[3]→Dₚ².

Consider filling the first planned data 430 and the second planned data 440 to its planned value. Assign the first available data 414 to the first planned data 430. Assign a third partial available data 422 with quantity 5 of second available data 416 to the first planned data 430 to fill first planned data 430 to its planned value 10. The third partial available data 422 fills the first planned data 430 as the third partial planned data 436. Filling the planned value of the first planned data 430 is achieved by summing first available data 414 and the third partial planned data 436 of the first planned data 430. In mathematical notation: Dₐ¹[5]+Dₐ²[5]→Dₚ¹. Assign a fourth available partial data 424 with quantity 3 of the second available data 416 to the second planned data 440 to fill second planned data 440 to its planned value 6. The fourth available partial data 424 fills the second planned data 440 as third partial planned data 446. In mathematical notation: Dₐ²[3]+Dₐ³[3]→Dₚ². Assign fifth available partial data 426 of the second available data 416 to the first planned data 430 to fill first planned data 430 above its planned value as fourth partial planned data 438. In mathematical notation: Dₐ¹[5]+Dₐ²[6]→Dₚ¹.

The assignment result for business scenario 400 is a first assignment result Dₐ¹[T₁−2 days, 5]+Dₐ²[T₁+5 days, 6]→Dₚ¹[T₁, 10, T₁−2 days, T₁+1 day, 9, 12] and the second assignment result is Dₐ²[T₁+5 days, 3]+Dₐ³ [T₁+11 days, 3]+Dₐ²[T₁+15, 6, T₁+13 days, T₁+16 days, 5, 8].

The time instance of the first available event in the first assignment lies within the time tolerance: T₁−2 dε[T₁−2 days, T₁+1 day], but the time instance of the second available data T₁+5 d is above the maximum time tolerance value of [T₁−2 days, T₁+1 d]. The total quantity of the available events 5+6=11 lies within the maximum quantity tolerance value [9, 12]. Therefore the deviation result for the first planned data 430 is quantity within tolerance value and late completion.

Time instances of the available events T₁+5 d and T₁+11 d are below the minimum tolerance value of the planned data [T₁+13 days, T₁+16 d]. The total quantity of the available events 3+3=6 lies within the maximum quantity tolerance value [5, 8]. Therefore the deviation result for the second planned data is quantity within tolerance value and early completion.

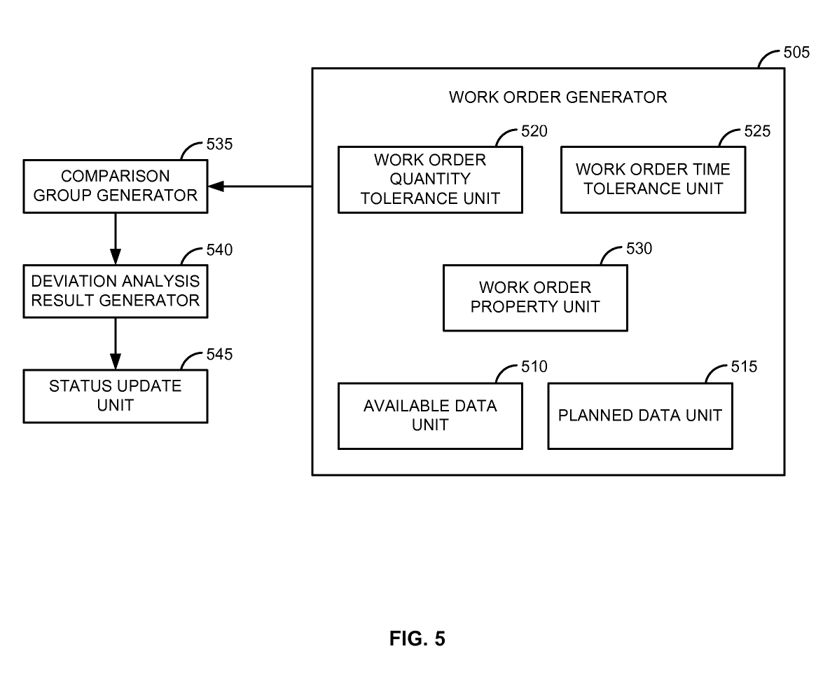

FIG. 5 is a block diagram of a system for generating a deviation result for a work order according to an embodiment of the invention. A work order generator 505 is connected to a comparison group generator 535. The work order generator 505 includes an available data unit 510, a planned data unit 515, a work order quantity tolerance unit 520, a work order time tolerance unit 525 and a work order property unit 530. The available data unit 510 provides an available data at a supplier end. The available data unit 510 stores an available data. The available data includes a quantity at a time instance. The planned data unit 515 provides a planned data required by a customer from the supplier end. The planned data unit 515 stores the planned data. The work order quantity tolerance unit 520 provides a minimum tolerance quantity value and a maximum tolerance quantity value for the planned data. The minimum tolerance quantity value and the maximum tolerance quantity value is termed as tolerance quantity value. The work order quantity tolerance unit 520 stores the tolerance quantity value. The work order time tolerance unit 525 provides a minimum time tolerance value and a maximum time tolerance value for the planned data. The minimum time tolerance value and the maximum time tolerance value are termed as time tolerance value. The work order time tolerance unit 525 stores the time tolerance value. The work order property unit 530 stores work order property data that may include a comparison type, customer details, supplier details, product details, an input output type, a phase type, a phase structure identifier and a phase identifier. The work order generator 505 generates a work order. The comparison group generator 535 connected to the work order generator 505 generates a comparison group on receiving the work order from the work order generator 505. A deviation analysis result generator 540 is connected to the comparison group generator 535 to generate a deviation analysis result. The deviation analysis result generator 540 generates the deviation analysis result for the comparison group received form the comparison group generator 535. A status update unit 545 connected to the deviation analysis result generator 540 updates a status of the work order based on the deviation analysis result.

It should be appreciated that reference throughout this specification to one embodiment or an embodiment means that a particular feature, structure or characteristic described in connection with the embodiment is included in at least one embodiment of the present invention. These references are not necessarily all referring to the same embodiment. Furthermore, the particular features, structures or characteristics may be combined as suitable in one or more embodiments of the invention.

What is claimed is:

1. A method comprising:
initiating a deviation analysis for a work order;
determining a comparison group for the deviation analysis based on an available data and a planned data;
generating a deviation analysis result for the comparison group; and
updating a status of the work order with the deviation analysis result.

2. The method of claim 1, wherein initiating a deviation analysis for a work order further comprises evaluating a supplier work order confirmation by a customer.

3. The method of claim 1, wherein initiating the deviation analysis for a work order further comprises triggering a work order progress check by analyzing a system event.

4. The method of claim 1, wherein generating a deviation analysis result for the work order further comprises determining a time tolerance result for the comparison group.

5. The method of claim 1, wherein generating a deviation analysis result for the work order further comprises determining a quantity tolerance result for the comparison group.

6. The method of claim 1, wherein generating a deviation analysis result for the comparison group further comprises:
assigning a first available data to a first planned data for determining an assignment result;
assigning a partial second available data to the first planned data to fill the first planned data to a minimum tolerance value;
assigning the partial second available data to the first planned data to fill the first planned data to a planned value;
assigning the partial second available data to the first planned data to fill the first planned data to a maximum tolerance value;
generating the assignment result; and
determining the deviation analysis result based on the assignment result.

7. The method of claim 1, wherein the deviation analysis result further comprises a quantity deviation result and a time deviation result.

8. The method of claim 7, wherein the quantity deviation result comprises a quantity value lower than a quantity tolerance value.

9. The method of claim 7, wherein the quantity deviation result comprises a quantity value within the quantity tolerance value.

10. The method of claim 7, wherein the quantity deviation result comprises a quantity value higher than the quantity tolerance value.

11. The method of claim 7, wherein the time deviation result comprises a completion time of the work order earlier than the time tolerance value.

12. The method of claim 7, wherein the time deviation result comprises a completion time of the work order within time tolerance value.

13. The method of claim 7, wherein the time deviation result comprises a late completion time of the work order than the time tolerance value.

14. A system comprising:
a work order generator for generating a work order;
a comparison group generator electronically coupled to the work order generator for generating a comparison group;
a deviation analysis result generator electronically coupled to the comparison group generator to generate the deviation analysis result; and
a status update unit electronically coupled to the deviation analysis result generator for updating the status of a work order.

15. The system of claim 14, wherein the work order generator further comprises an available data unit for storing an available data.

16. The system of claim 14, wherein the work order generator further comprises a planned data unit for storing a planned data.

17. The system of claim 14, wherein the work order generator further comprises a work order quantity tolerance unit for storing a work order quantity tolerance unit.

18. The system of claim 14, wherein the work order generator further comprises a work order time tolerance unit for storing a work order time tolerance value.

19. The system of claim 14, wherein the work order generator further comprises a work order property unit for storing a work order property data.

20. A machine-accessible medium that provides instructions which, when executed by a machine, cause the machine to perform operations comprising:
initiating a deviation analysis for a work order;
determining a comparison group for the deviation analysis for the work order based on an actual data and planned data;
generating a deviation analysis result for the comparison group; and
updating a status of the work order based on the deviation analysis result.
